(19) United States
(12) Patent Application Publication
(10) Pub. No.: US 2008/0036217 A1
(43) Pub. Date: Feb. 14, 2008

(54) Double door hook for an oven

(76) Inventor: Ching-Hsiang Wang, Tainan City (TW)

Correspondence Address: Ching-Hsiang WANG, P.O. BOX 90, Tainan City, 70499, omitted

(21) Appl. No.: 11/501,783

(22) Filed: Aug. 10, 2006

(51) Int. Cl. E05C 1/04

(52) U.S. Cl. 292/146

(57) ABSTRACT

A double door hook for an oven includes a double door hook fixed on an inner surface of the door of an oven, and a hooking device fixed on a frame of a housing of the oven. The frame has a hole, and the looking device is just located behind the hole, which the double door hook faces to. The hooking device is composed of a fix base fixed on the frame, two support strips pivotally connected to the fix base, and a coil spring. Then a coil spring is deposited between the rear end of the two support strips. When the door is swung to close on the housing, the double door hook moves through the hole and hooks with the hooking device, securing the door tightly with the housing and preventing the inner heat in the oven from leaking out for saving energy cost.

### BACKGROUND OF THE INVENTION

1. Field of the Invention

This invention relates to a double door hook for an oven, particularly to one fixed on the door of an oven to firmly keep the door of the oven to be closed tightly on the housing of the oven so that the inner heat of the oven may not leak out, as no gaps between the door and the housing may be formed in case of the door is closed.

2. Description of the Prior Art

A door hook for a conventional oven shown in FIGS. 1 and 2 includes a door 10 and a housing 11 having one vertical side pivotally connected with the door 10. The door 10 has a hook 12 fixed on an inner surface, and the housing 11 has a hole 13 in a front surface and a retainer 14 fixed in the hole 13 and consisting of two pinching strips 15, a coil spring 15 and a shaft 16. When the door is closed on a front open side of the housing 11, the hook 12 fits in the space between the two pinching strips 15, securing the door 10 immovable with the housing 11.

However, the coil spring 16 may get loose gradually owing to a long period of use, causing the two pinching strips 15 impossible to clamp the hook 12 tightly therebetween, resulting in the door 10 impossible to be closed tightly but loosely with the housing 11 so that a gap can be formed between the door 10 and the housing 11. Then the heat in the interior of the housing 11 may leak out, needing comparatively long time to reach a preset temperature, wasting energy cost not a little.

### SUMMARY OF THE INVENTION

This invention has been devised to offer a double door hook for an oven, which can permit the door to be closed always tightly on the housing by means of the double door hook.

The feature of the invention is a double door hook fixed on the door of the oven and a hooking device fixed on the housing. The door is pivotally connected to a vertical side of the housing, When the door is swung to close on the housing, the double door hook moves to insert through a hole in the frame of the housing to hook with two support strips of the hooking device tightly, and the two support strips are pivotally connected to a fix base of the hooking device, and a coil spring is deposited between the rear end of the two support strips to let the two support strips swing inward and outward to hook with or separate from the support strips so the door may be closed tightly or opened easily.

### BRIEF DESCRIPTION OF DRAWINGS

This invention will be better understood by referring to the accompanying drawings, wherein:

FIG. 1 is a perspective view of a door hook for a conventional oven;

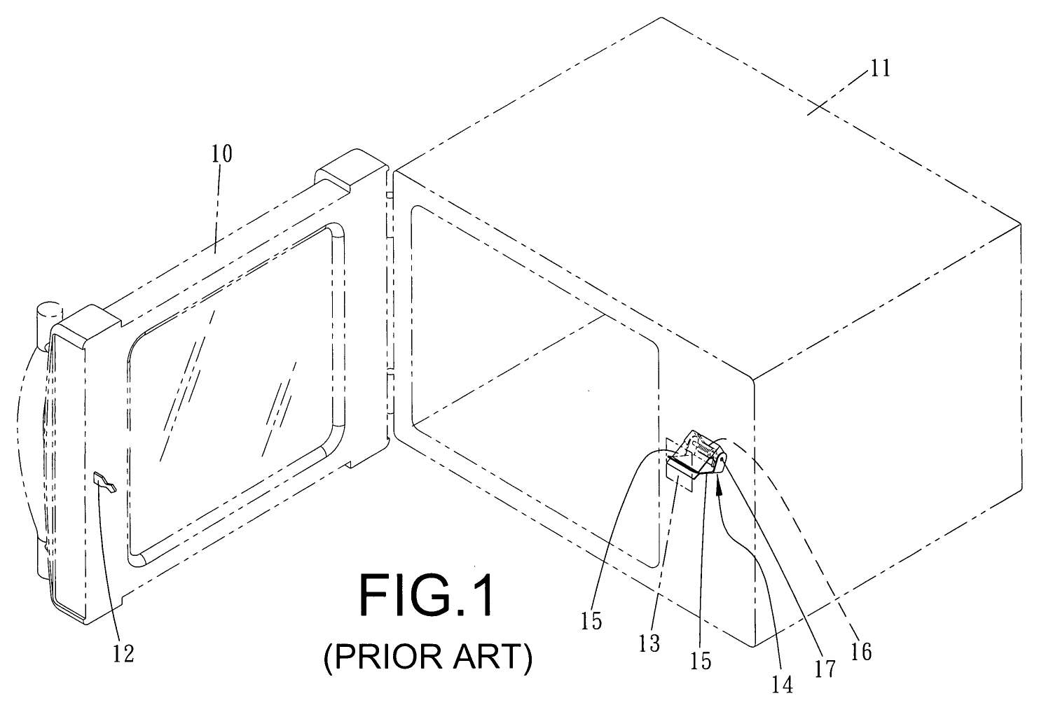

FIG. 2 is a side view of the door hook for a conventional oven;

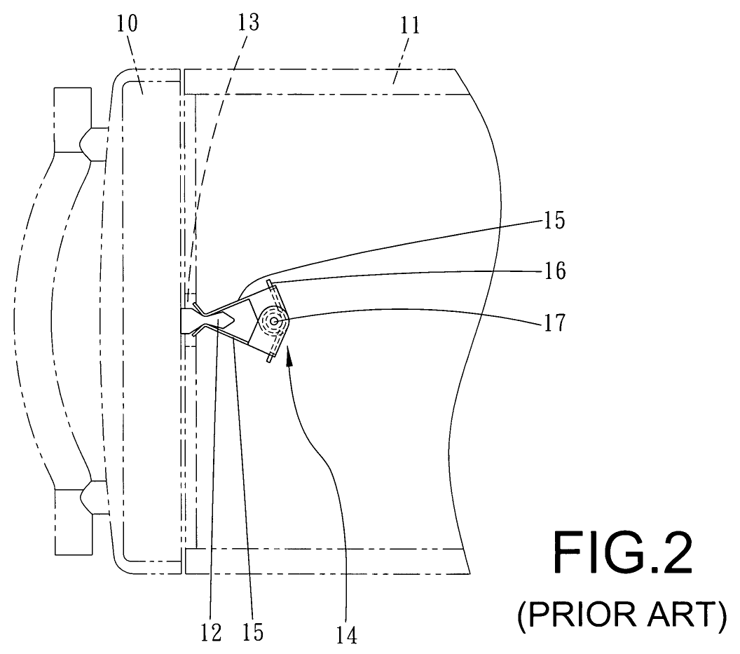

FIG. 3 is a perspective view of a double door hook for an oven in the present invention;

FIG. 4 is a side view of the door with the double door hook not yet closed on the housing of an oven in the present invention;

FIG. 5 is a side view of the double door hook being moved to hook a hooking device in the present invention; and,

FIG. 6 is a side view of the door completely closed on the housing, with the double door hook hooked totally with the hooking device in the present invention.

### DETAILED DESCRIPTION OF THE PREFERRED EMBODIMENT

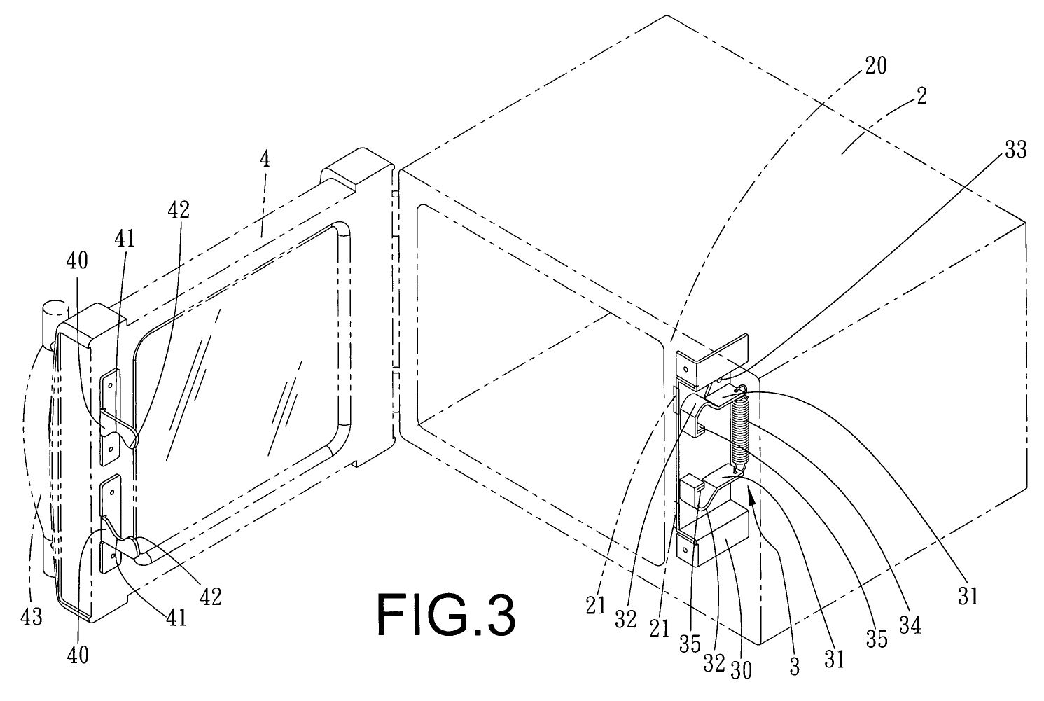

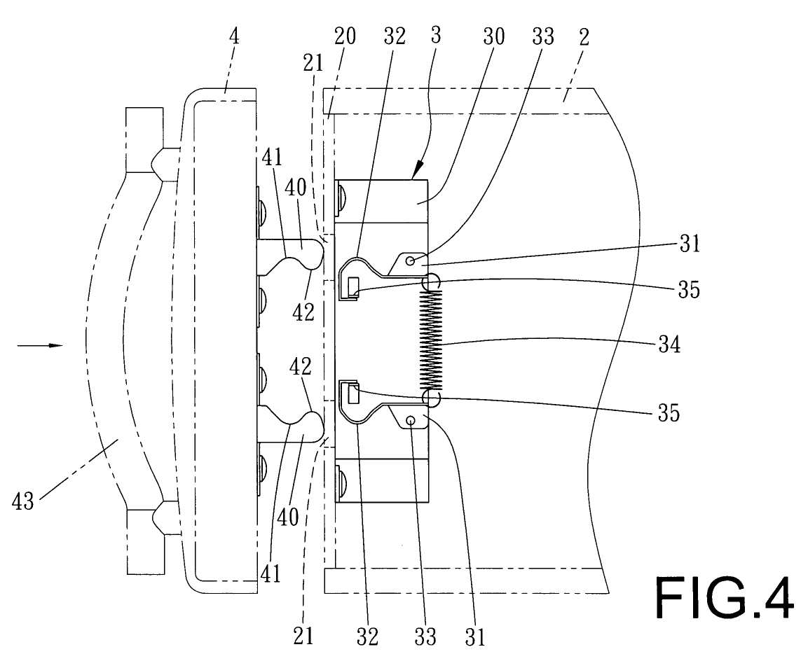

A preferred embodiment of a double door hook for an oven in the present invention, as shown in FIGS. 3 and 4, includes a hooking device 3 fixed on the frame of a housing 2, and a double door hook 40 fixed on an inner surface of a door 4 as main components combined together.

The housing 2 has a frame, whose vertical side 20 is fixed with the hooking device 3 that is composed of a fix bases 30 fixed on the vertical side 20 of the frame, two support strips 31 fixed spaced apart on the fix base 30. Each support strip 31 has a curved portion 32, pivotally connected with the fix base 30 with a pivot 33, and a coil spring 34 is deposited between the rear end of the two support strips 31, with the two ends of the spring 34 hooked with an outer end of the two support strips 31 respectively. Further, the fix bases 30 have two stop projections 35 spaced apart on its surface for stopping and securing temporarily the two support strips 31 at that stopped position.

The door 4 is pivotally connected to a vertical side of the housing 2, able to be swung to open or close on the housing, and the double hook 40 is fixed on an inner surface of the door 4, and provided with two horizontal hook members spaced apart vertically, and each hook member having a concave recess 41 and a curved tips 42 facing to the hole 21 of the frame of the housing 2, and a grip 43 fixed on an outer surface of the door 4.

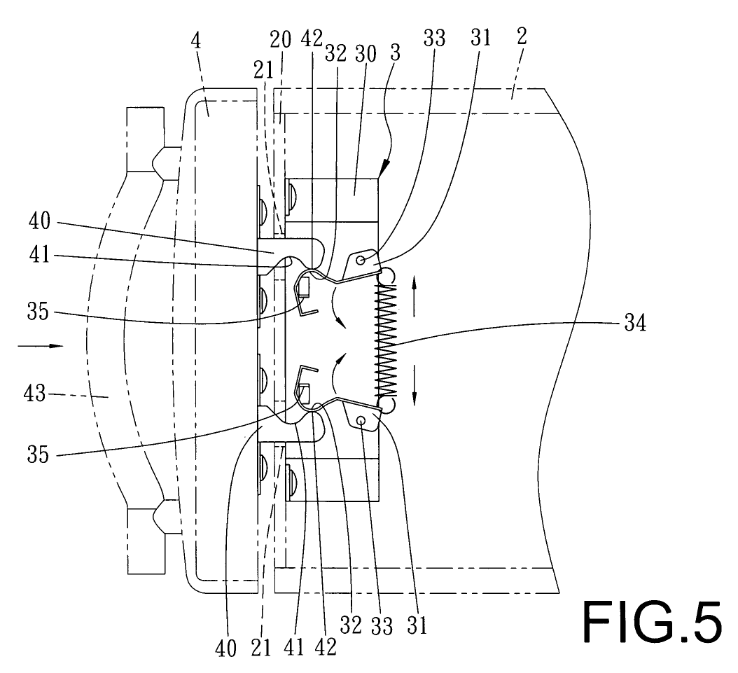

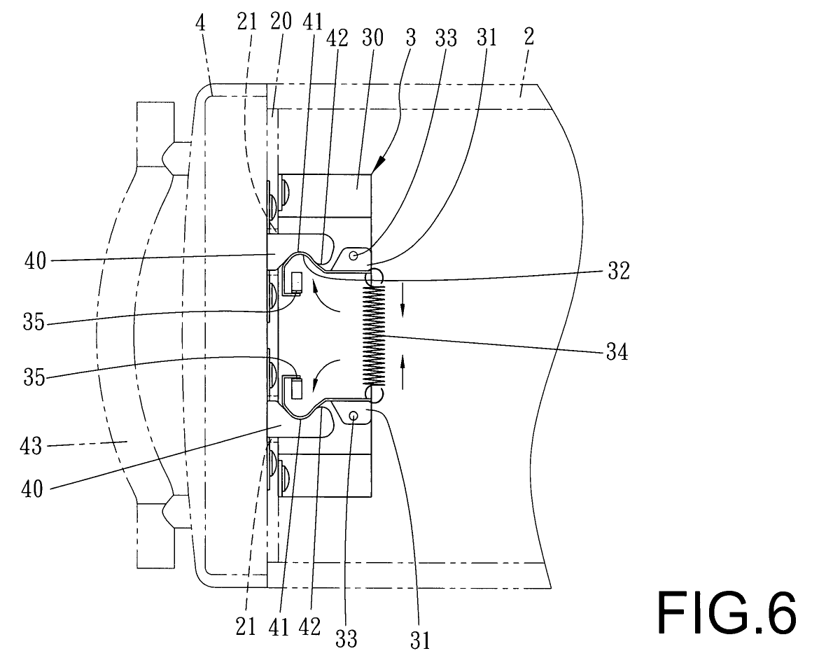

In using, as shown in FIGS. 4, 5 and 6, in case the door 4 is to be closed on the housing 2 from the opened position, the grip 43 is held with a hand and the door 4 is swung to close on the front opening of the housing 2, with the double hook 40 fitting in the hole 21 of the housing 2 and pushing the curved portion 32 of the two support strips 31 with the curved tips 42, forcing the two support strips 31 to swing outward a little with the pivot 33, as shown in FIG. 5. Then the outer end of the two support strips 31 extend inward, with the coil spring 34 pulled to lengthen. As the double hook 40 moves further inward to let the concaved recesses 41 fit with the curved portions 32 of the two support strips 31, and at the same time permitting the coil springs 34 to shrink elastically back to its original condition and pulling back the outer end of the two support strips 31, securing the double hook 40 in position with the door 4 stably closed on the housing 2, preventing any gaps from occurring between the door 4 and the housing, as shown in FIG. 6. In this way, the heat in the interior of the housing 2 can be prevented from leaking out, swiftly raised up to a present temperature, saving energy cost not a little.

On the contrary, when the door 4 closed is needed to be opened, only hold the grip 43 on the door 4 and pull outward the door 4 forcing the curved ends 42 of the double hook 40 push the curved portions 32 of the two support strips 31 outward, with the end of the two support strips 31 moving nearer to each other, and with the curved portion 32 completely separating from the concave recess 42 of the double hook 40. Then the door 4 becomes free to swing to be opened easily.

While the preferred embodiment of the invention has been described above, it will be recognized and understood that various modifications may be made therein and the appended claims are intended to cover all such modifications that may fall within the spirit and scope of the invention.

What is claimed is:

1. A double door hook for an oven, said double door hook comprising a double hook and a hooking device;
said double hook fixed on a door of an oven and provided with two horizontal hook members spaced apart to locate to face a hole of a frame of a housing of said oven, said door pivotally connected to a vertical side of said housing; and,
said hooking device fixed said frame of said housing at a rear side of said hole and composed of a fix base and two support strips and a coil spring, said fix base fixed vertically on said frame, said two support strips pivotally connected spaced apart to said fix base, said coil spring deposited between an inner end of said two support strips.

2. The double door hook as claimed in claim 1, wherein said two support strips are provided with a convex portion facing to each other.

3. The double door hook as claimed in claim 1, wherein said two hook members of said double door hook are provided respectively with a convex recess and a curved end.

4. The double door hook as claimed in claim 1, wherein said fix base is provided with two stop projections spaced apart on its surface for stopping and securing said two support strips at that stopped position temporarily.
